(19) United States
(12) Patent Application Publication
(10) Pub. No.: US 2020/0004299 A1
(43) Pub. Date: Jan. 2, 2020

(54) SYSTEM, METHOD AND APPARATUS FOR AN ELECTRONIC DEVICE FOR A TABLET COMPUTER

(71) Applicant: Scaler Technology Co., Ltd., Shenzhen (CN)

(72) Inventors: Jing Cai, Dongguan (CN); Tianliang Yuan, Dongguan (CN); Zhang Sheng, Dongguan (CN); Jeremy Baldwin, Houston, TX (US)

(21) Appl. No.: 16/565,155

(22) Filed: Sep. 9, 2019

Related U.S. Application Data
(63) Continuation of application No. 29/654,079, filed on Jun. 21, 2018.
Application No. 29/654,079 is a continuation of application No. 29/703,145, filed on Aug. 23, 2019.

(30) Foreign Application Priority Data
Jan. 29, 2019 (CN) 201920167735.1
Mar. 23, 2019 (CN) 201930123668.9

(51) Int. Cl. G06F 1/16

(52) U.S. Cl. CPC G06F 1/1669; G06F 1/1626; G06F 1/1616; G06F 1/1683; G06F 1/1632; G06F 1/1681

(57) ABSTRACT

Some embodiments of the present disclosure relate to an electronic device. The electronic device may include a housing configured to releasably mount a tablet computing device thereto, and a base hingedly coupled to the housing, the base including a keyboard configured to interface with the tablet computing device, the base also including a top on which the keyboard is located, a bottom opposite the top, the bottom having a bottom surface that is flat and a curved surface adjacent a perimeter of the base, the curved surface extends between the flat bottom surface and the top, and the base further includes footpads on the curved surface.

### CROSS-REFERENCE TO RELATED APPLICATIONS

This application claims priority to U.S. patent application Ser. No. 29/654,079, filed Jun. 21, 2018, U.S. patent application Ser. No. 29/703,145, filed Aug. 23, 2019, CN Pat. App. No. 201920167735.1, filed Jan. 29, 2019, and CN Pat. App. 201930123668.9, filed Mar. 23, 2019, each of which is incorporated herein by reference in its entirety.

### TECHNICAL FIELD

This application generally relates to electronic devices and, in particular, to a system, method and apparatus for an electronic device for a tablet computer.

### STATEMENT OF FEDERALLY FUNDED RESEARCH

None.

### BACKGROUND OF THE DISCLOSURE

The tablet computer, also known as a tablet personal computer, tablet PC, tablet computing device, flat PC, phone-tablet (e.g., a “phablet” that includes the features of a tablet as well as the capability to make telephone calls via a network (cellular, WiFi, etc.)), tablet or slate, is a small, portable (e.g., mobile) personal computer with a touchscreen as a basic input device. The term “portable” or “mobile” may refer to the personal computer as having a small form factor and being designed to be transported from place to place. Portable personal computers may be primarily battery powered devices with base computing resources in the form of processes, memories, storage and network access. Tablets do not have a keyboard or touchpad, and touchscreen writing is slower and less convenient than using a keyboard. Although tablets are functional, improvements in electronic devices continue to be of interest.

### SUMMARY OF THE DISCLOSURE

Embodiments of a system, method and apparatus for an electronic device for a tablet computer are disclosed. For example, the electronic device can include a housing that is configured to releasably mount the tablet computer thereto. The electronic device also can include a base hingedly coupled to the housing. The base can include a keyboard and touchpad that are configured to interface with the tablet.

Some embodiments of the present disclosure relate to an electronic device. The electronic device may include a housing for releasably mounting a tablet computing device, and a base rotatably coupled to the housing. The base may include a processing device capable of executing instructions and communicatively coupled to the tablet computing device, a touchpad communicatively coupled to the processing device, and the touchpad is capable of receiving a gesture and transmitting a first instruction pertaining to the gesture to the processing device. The processing device generates a second instruction based on the first instruction and transmits the second instruction to the tablet computing device to cause an operation to be performed by an operating system executing on the tablet computing device or another device in a master-slave relationship

In some embodiments, a method may include receiving, at a processing device, a first instruction from a touchpad of a base. The first instruction pertains to a gesture made on the touchpad by a user. The base may include the processing device and the touchpad. The processing device is communicatively coupled with the touchpad and a tablet computing device. The tablet computing device is releasably mounted within a housing attached to the base. The method may also include generating a second instruction based on the first instruction, and transmitting the second instruction to the tablet computing device to cause the tablet computing device to perform an operation based on the second instruction.

Some embodiments may include a tangible, non-transitory computer-readable medium storing instructions that, when executed, cause a processing device to perform one or more of the operations described above.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description can be had by reference to the embodiments thereof that are illustrated in the appended drawings. However, the drawings illustrate only some embodiments and therefore are not to be considered limiting in scope as there can be other equally effective embodiments.

FIG. 1 is an isometric view of one embodiment of an electronic device for a tablet computer, shown in an open or use configuration.

FIG. 2 is an exploded view of an embodiment of the electronic device.

FIG. 3 is an isometric view of an embodiment of the electronic device shown wherein a tablet computer is mounted to it in the open configuration.

FIG. 4 is a bottom isometric view of an embodiment of the electronic device in a closed or non-use configuration.

FIG. 5 is an isometric view of an embodiment of a hinge.

FIG. 6 is an isometric view of an embodiment of a nut.

FIG. 7 is an isometric view of an embodiment of a cable.

FIG. 8 is a top isometric view of an embodiment of a keyboard of the electronic device, where the keyboard includes single respective buttons to pair the electronic device with the tablet computer, to control backlight brightness of the keyboard, and to control the color of the keyboard.

FIG. 9 is an isometric view of an embodiment of a cable connected to the tablet computer, the electronic device, and a cord.

FIG. 10 is a high-level component diagram of the system architecture of the electronic device removably securing the tablet computer in the housing.

FIG. 11 is a component diagram of an embodiment of an electronic device including a keyboard and a voice-controlling integrated circuit.

FIG. 12 is a component diagram of an embodiment of an electronic device including a keyboard.

FIG. 13 is a component diagram of an embodiment of an electronic device including a keyboard and a touchpad.

FIGS. 14A-14D are isometric views of embodiments of using touch motions on a touchpad to cause an operation to be performed on a tablet computer.

FIG. 15 is an isometric view of an embodiment of touching a portion of the touchpad to cause a contextual menu to be presented on the tablet computer.

FIG. 16 is an isometric view of an embodiment of pressing a function key to cause certain LEDs to illuminate selected keys.

FIG. 17A-17B are isometric views of embodiments of pressing a help key to cause tutorials pertaining to how to use the electronic device to be presented on the tablet computer.

FIG. 18 is an isometric view of an embodiment of a user causing text to be presented on the tablet computer by talking into the electronic device.

FIG. 19 is an example flow diagram of a method for using a touchpad of an electronic device to cause an operation to be performed on a tablet computer.

FIG. 20 is an example flow diagram of a method based on guidance of a tutorial presented on the tablet computer for changing a color of a light-emitting diode associated with a key of an electronic device.

FIG. 21 is an example flow diagram of a method based on information received from the tablet computer for changing a color of a light-emitting diode included in the base.

The use of the same reference symbols in different drawings indicates similar or identical items.

### DETAILED DESCRIPTION OF THE DISCLOSURE

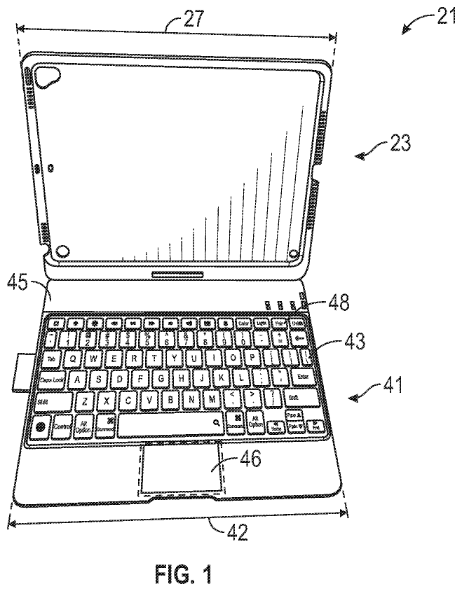

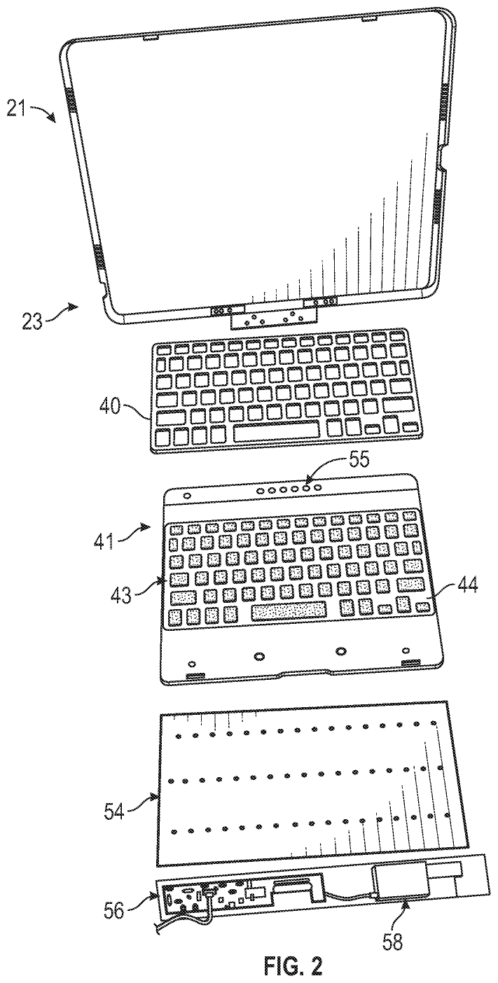

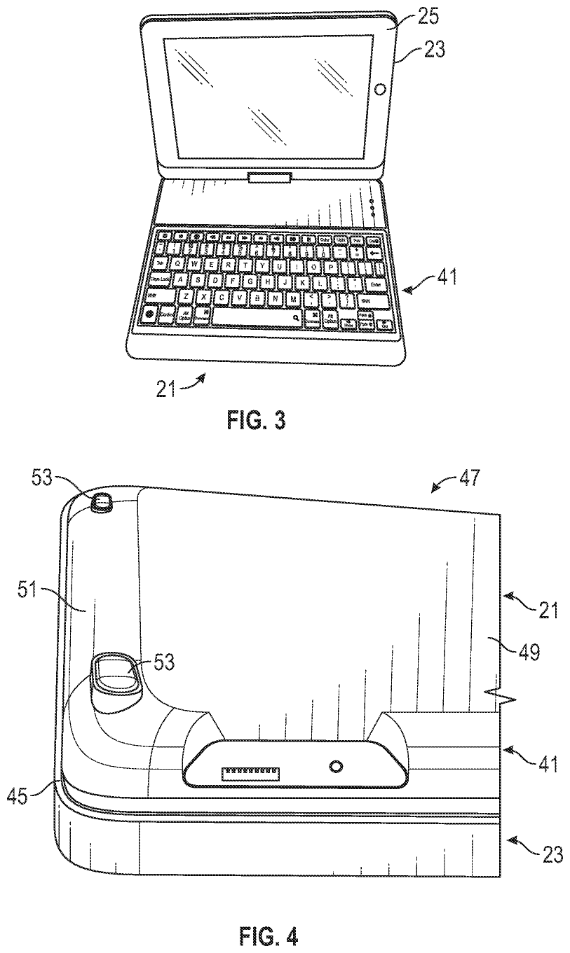

FIGS. 1-21 depict various embodiments of a system, method and apparatus for an electronic device for a tablet computer. For example, an electronic device 21 can include a housing 23. The housing 23 can be configured to releasably mount a tablet computer 25 (FIG. 3) thereto. The electronic device 21 also can include a base 41. The base 41 can be movably (e.g., hingedly) coupled to or with the housing 23. The phrases ‘coupled to’ and ‘coupled with’ may be used interchangeably. The base 41 can include a keyboard 43 that can be configured to interface with the tablet computing device 25. As shown in FIG. 2, the base 41 can further include a backlight board 54, printed circuit board assembly (PCBA) 56 and battery 58.

A backlight board 54 may include a number of red-green-blue (RGB) light-emitting diodes (LEDs). The terms “RGB LED” and “LED” may be used interchangeably herein. The LEDs may be disposed on a first side of the backlight board 54 and traces to the LEDs may be disposed on a second side opposite the first side. The first side including the LEDs may face toward the keys of the keyboard 43. An acrylic board is transparent or substantially transparent and is capable of conducting light may be included in the base 41 above the backlight board 54. The LEDs may shine light through the acrylic board to illuminate each key. The keys may be laser carved or etched such that the word or printing (e.g., letter, number, symbol) on the keys appears transparent and bright.

In one embodiment, 60-90 LEDs (e.g., 80 LEDs) may be included on the backlight board 54. The RGB LEDs refer to the LED having 3basic color chips inside each RGB LED, so (in one version) each RGB LED can produce seven colors (e.g., red, blue, green, yellow, purple, cyan, orange). For example, the color produced by each RGB LED can be a determined by a number (0-255) for R, G, and B (e.g., 255, 128, 40). The number of possible colors for each LED can be 256\hat{ }3, or about 16.7 million colors. The embodiment with 81 LEDs can produce a seamless color gradient “wave” effect, whereas the embodiment with 7 LEDs can have only 10 pre-programmed colors in its current iteration. In another example, basic colors can include red light, green light and blue light. Yellow light may be produced by combining green light and red light. Cyan-blue light may be produced by combining green light and blue light. Purple light may be produced by combining red light and blue light. In some embodiments, the LEDs may illuminate at the same time, or be controlled individually to illuminate at different times.

In another embodiment, the PCBA 56 can control power consumption of the LEDs using pulse-width modulation. Pulse-width modulation may refer to a method of reducing the average power delivered by an electrical signal, by effectively dividing or chopping it up into discrete parts. The average value of voltage (and current) fed to the load is controlled by turning the switch between supply and load on and off at a fast rate. In some embodiments, if each LED consumes 5 millamperes (mA), and the battery used to power the LEDs is 4 volts, consumption is 400 mA if 80 LEDs turn on. To reduce the power consumption and save battery life, the LEDs may be set to a certain percentage of their maximum lighting to maintain power consumption of the battery to a specified range (e.g., 200-300 mA) using pulse-width modulation. In one example, the power consumption of the 80 LEDs may be operated at 280 mA.

In some embodiments 1-10 LEDs (e.g., 7 LEDs) may be included in the backlight board 54. If each LED consumes 30 mA and the battery is 4 volts, power consumption is 210 mA if 7 LEDs turn on. The actual consumption may depend on desired battery performance.

The PCBA 56 may refer to a printed circuit board that includes electronic components and parts soldered and installed on a printed circuit board. In some embodiments, the electronic components and parts of the PCBA 56 may include a processing device, a memory device, a network interface device, a voice-controlling integrated circuit, or any suitable component capable of performing the techniques described herein.

The battery 58 may refer to a container consisting of one or more cells, in which chemical energy is converted into electricity and used as a source of power. The battery 58 may be any suitable battery capable of powering the electrical components included in the base 41. The battery 58 may be electrically coupled to the PCBA 46, a touchpad, the keyboard 43, the backlight board 58, and the like.

In some versions, the base 41 can include a top 45 on which the keyboard 43 is located. The base 41 also can have a bottom 47 (FIG. 4) opposite the top 45. The bottom 47 can include a bottom surface 49 that is flat. A curved surface 51 can be located adjacent a perimeter of the base 41. The curved surface 51 can extend between the flat bottom surface 49 and the top 45. The base 41 also can include footpads 53. The footpads 53 can be located on the curved surface 51. In some embodiments, the footpads 53 can be entirely located on the curved surface 51 and not on the flat bottom surface 49.

Examples of the footpads 53 can be located within 10 mm of the perimeter. In other examples, the footpads 53 can be within 8 mm of the perimeter, such as within 6 mm, within 4 mm or even within 2 mm of the perimeter. Versions of the footpads 53 can be sloped, as shown. Positioning the footpads 53 in these ways can improve the stability of the electronic device 21. For example, embodiments can reduce the likelihood of the electronic device 21 tipping over in response to user contact with it or with the tablet computing device 25 mounted in the electronic device 21.

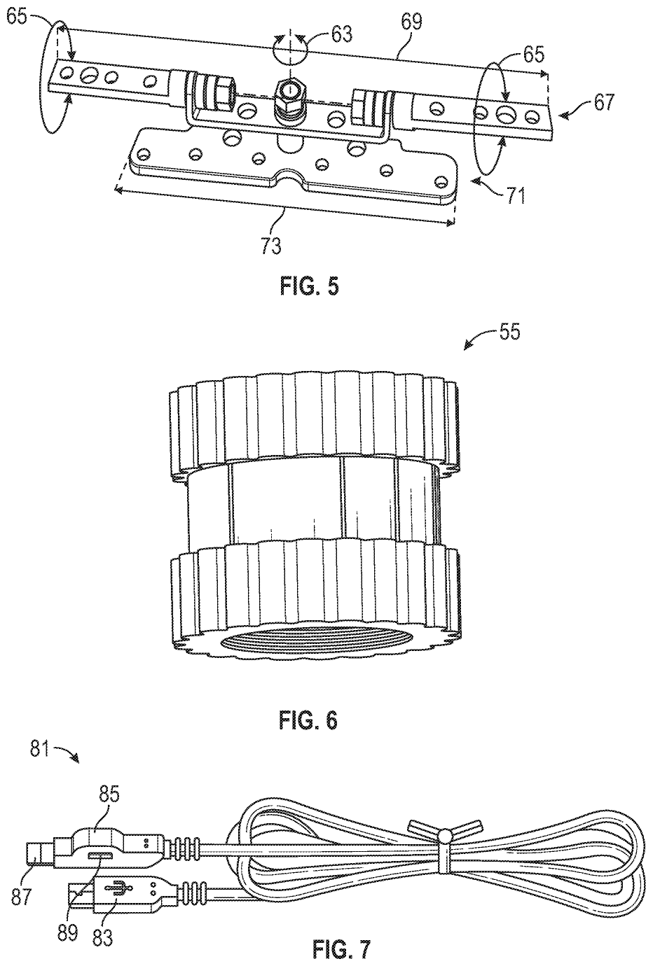

As shown in FIG. 5, embodiments of the electronic device 21 can include a hinge 61. The hinge 61 can be mounted to both the housing 21 and the base 41. The hinge 61 can have a first degree of freedom 63 about a vertical axis (e.g., the center post) of the hinge 61 and configured to rotate or swivel the housing 21 relative to the base 41. In addition, the hinge 61 can have a second degree of freedom 65 configured to rotate or fold the housing 21 relative to the base 41 parallel or substantially parallel to their respective perimeter edges. One or more additional degrees of freedom also may be employed.

Versions of the hinge 61 can include a housing mount 67 having a housing mount width 69. The housing 21 can have a housing width 27 (FIG. 1). In an example, the housing mount width 69 can be in a range of about 42% to about 60% of the housing width 27. In another example, the housing mount width 69 can be in a range of about 43% to about 50% of the housing width 27. The housing mount 67 can be significantly wider than conventional designs, and accommodate additional fasteners to secure the housing 21 to the base 41.

Embodiments of the hinge 61 can include a base mount 71 (FIG. 5) having a base mount width 73. The base 41 can have a base width 42 (FIG. 1). In an example, the base mount width 73 can be in a range of about 20% to about 35% of the base width 42. In another example, the base mount width 73 can be in a range of about 28% to about 33% of the base width 42. The hinge 61 can be formed from superior materials and thicknesses than can conventional designs. For example, the hinge 61 can be formed from SK7 steel material. In another example, the housing mount 67 can have a thickness of 1.5 mm, rather than a thickness of only 1.2 mm. These various improvements embodied in hinge 61 can improve its life of use by 100%, 500% or even 1000% compared to that of conventional designs. The strength of hinge 61 is less prone to cracking, and also can help ensure that housing 21 stays parallel to base 41.

Versions of the electronic device 21 can include fabricating the housing 21 and the base 41 by injection molding them. In some examples, each of the housing 21 and the base 41 can include nuts 55, such as a non-corrodible material like copper. The nuts 55 can be used to secure the hinge 61 to the housing 21 and base 41 with fasteners, such as screws. In an embodiment, the nuts 55 can be mounted in the housing 21 and the base 41 during the injected molding process.

Embodiments of the electronic device 21 can include a cable 81 (FIG. 7), such as a power cable. In an example, the cable 81 can include a male connector 83, such as a unidirectional connector (e.g., USB connector), on a first end. The cable 81 also can include a second end having a head 85. The head 85 can include a different male connector 87, such as a male dual-directional insertion connector (e.g., male Lightning connector by Apple), and a different female connector 89, such as a female dual-directional connector (e.g., a female Lightning connector by Apple).

As shown in the drawings, the base 41 can include keyholes through which respective keys on the keyboard 43 protrude. The base 41 can have an interior surface 44 (FIG. 2) that is visible to a user through the keyholes, especially when the backlighting is on. The gap between the keys and the keyboard frame or grill can be about 0.5 mm. The keys have a key color, such as a dark color like black, and the interior surface 44 can have an interior surface color that is a light color like white or light gray. In some versions, the interior surface can have a light reflectance value (LRV) in a range of about 50% to about 80%, such as about 60% to about 75%. The key color can have a LRV that is less than about 40%.

Embodiments of the base 41 can include a touchpad 46 configured to interface with the tablet computing device 25. The touchpad 46 may be communicatively coupled with the processing device of the PCBA 56. For example, the touchpad 46 may include a touch chip that shares an electrical connection with the processing device such that the touch chip is able to communicate instructions to the processing device. The touchpad 46 may refer to a surface that can translate the motion and position of an object (e.g., user's finger) to a relative position on a user interface of another device (e.g., tablet computing device 25) that causes an operation to be performed at the relative position. The touchpad 46 may operate by using a change of capacitance where a finger touches the touchpad 46. The touchpad 46 may include tactile sensors that connect movements on the touchpad 46 to a corresponding position on a user interface of the tablet computing device 25. In some embodiments, the sensors may connect movements on the touchpad 46 to a cursor presented on the user interface of the tablet computing device 25.

In some embodiments, a user may perform a gesture on the touchpad 46. The gesture may be a single-touch motion (e.g., tap) with one finger or a multi-touch motion with more than one finger (e.g., 2, 3, 4, 5, etc.). The touchpad 46 may capture the gesture using the sensors and the touch chip may transmit one or more first instructions pertaining to the gesture to the processing device of the electronic device 21. Computer instructions (e.g., touchpad device driver software) may be stored on a memory device of the electronic device 21 that, when executed by the processing device, receive the one or more first instructions from the touchpad 46 (e.g., touch chip). The processing device may process the one or more first instructions to generate one or more second instructions.

Generating the one or more second instructions may include translating the one or more first instructions based on a type of operating system executing on the tablet computing device 25. For example, different types of operating systems may implement different interfaces and/or specifications for accessing resources of the computing device on which the operating systems are executing. By generating the one or more second instructions based on the type of operating system executing on the tablet computing device 25, the processing device may generate the one or more second instructions that are compatible with any suitable operating system.

The operating system executing on the tablet computing device 25 may support any suitable type of networking protocol (e.g., Bluetooth, WiFi, ZigBee, Ethernet, etc.) and communication interface (e.g., USB, Apple Lightning®). Likewise, the processing device executing the computer instructions stored on the electronic device 21 may support any suitable type of networking protocol (e.g., Bluetooth, WiFi, NFC, ZigBee, Ethernet) and communication interface (e.g., USB, Apple lightning).

The processing device may transmit the one or more second instructions to the tablet computing device 25. The tablet computing device 25 may execute the one or more second instructions to perform an operation via the operating system executing on the tablet computing device 25. For example, if the gesture was a single-touch motion, the operation may include selecting an application to be opened by the operating system and the operating system opening the selected application. A single-touch motion followed by a continuous pointing motion or dragging motion may indicate a swiping or dragging, and may cause the operating system to switch from a currently selected application to a newly selected application. The speed of the gesture may cause the speed of the switching to be affected. For example, if the swipe gesture is slow, the available applications may be presented slowly. If the swipe gesture is fast, the available applications may be presented faster than when the swipe gesture is slow. Further, the single-touch motion followed by a continuous pointing motion or dragging motion may cause an object to be selected and dragged to another location.

There may be portions of the touchpad 46 where a gesture causes different operations to be performed via the operating system of the tablet computing device 25. For example, a first portion of the touchpad 46 may be touched or pressed by a user, and it may simulate a “right-click” of a mouse by opening a contextual menu on the user interface of the tablet computing device 25. The contextual menu may include options pertaining to settings of the tablet computing device 25 (e.g., display settings, audio settings, resource settings, etc.). The contextual menu may include options that allow the user to close an application. The contextual menu may include options that allow the user to uninstall an application. The contextual menu may include options (e.g., copy, paste, etc.) that are available within an executing application. Another portion of the touchpad 46 may be touched or pressed by a user, and it may simulate a “left-click” of a mouse by selecting an object (e.g., application, file, user interface element, etc.) presented on a user interface of the tablet computing device 25. Another portion of a touchpad may be touched by a user to program any portion of the tablet, such as a key, the keyboard, etc.

Other functionality associated with the touchpad 46 may include swiping a finger along a side of the touchpad 46 to cause the operating system of the tablet computing device 46 to perform a scroll wheel functionality, controlling a scroll bar vertically or horizontally of an application that is being selected. In some embodiments, the gesture may include multi-touch motion, for example, where the user uses more than one finger on the touchpad 46 to zoom in or zoom out on a portion of a user interface presented on the tablet computing device 25. In some embodiments, the user may use more than one finger on the touchpad 46 to cause the operating system to rotate a screen or object (e.g., a drawing, a model, etc.) presented by an application selected by the operating system. In some embodiments, the user may use more than one finger on the touchpad 46 to cause an object to grow in size or shrink in size.

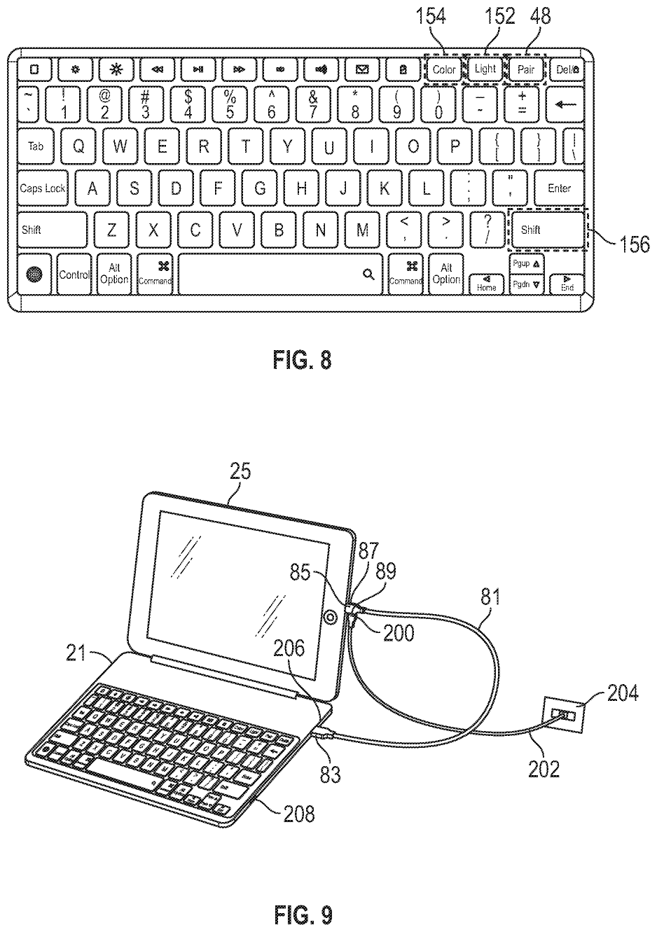

The keyboard 43 also can have dedicated single-touch function keys. For example, the keyboard 43 can include a “pair” key 48 (FIG. 8) for one-touch Bluetooth pairing of the electronic device 21 with the tablet computing device 25. For example, the pair key 48 may be pressed on the keyboard 43 to cause to a network interface device of the electronic device 21 to communicatively couple to a network interface device of the tablet computing device 25 via a protocol. In another example, a pen or stylus, such as a smart pen may be employed to interface with the tablet computing device 25.

The keyboard 43 may include a “color” key 154 (FIG. 8) for one-touch modification to a color being emitted by a light-emitting diode (LED) disposed proximate to a key on the keyboard 43. For example, there may be numerous LEDs disposed proximate to keys on the keyboard 43 (e.g., there may be a different respective LED disposed proximate to each key on the keyboard 43). Disposing an LED “proximate” to a key may refer to disposing the LED beneath the key, partially beneath the key, adjacent to the key, or partially adjacent to the key. Any suitable number of LEDs may be used (e.g., 1-90). In one example embodiment, 80 or 81 LEDs are used. In another example embodiment, 7 LEDs are used. In some embodiments, the LEDs are disposed on the backlight board 54 and may shine light through an acrylic board in between the LEDs and the keys of the keyboard 43. In some embodiments, the LEDs may shine through holes of the internal surface 44 on which the keyboard 43 is disposed. In some embodiments, the backlight board 54 may be overlaid on top of the internal surface 44 and corresponding keys may be assembled on the internal surface.

There may be traces on the side of the backlight board 54 opposite the side on which the LEDs are disposed. The traces may be electrically connected to a connector which is itself electrically connected and communicatively coupled to the processing device of the PCBA 56. Since the keyboard 43 is communicatively coupled to the processing device of the PCBA 56 when the color key 154 is pressed, the processing device may transmit instructions to the LEDs to control the color of the LEDs via the connector and traces. Pressing the color key 154 may cause the color of each LED to change from a current color to a next color in a cycle. The color key 154 may be used to control the color for each respective LED, for a subset of LEDs, or for the entire group of LEDs.

The keyboard 43 may include a “light” key 152 (FIG. 8) for one-touch modification to a brightness level of the LEDs. For example, the brightness level may be increased or decreased by pressing the light key 152. In some embodiments, the brightness level may be increased incrementally until a maximum brightness is reached by iteratively pressing the light key 152. A subsequent press may cause the brightness level to restart at a minimum brightness level. The light key 152 may be used to control the brightness level for each respective LED, for a subset of LEDs, or for the entire group of LEDs. The processing device may transmit instructions to the LEDs to control the color the LEDs via the connector and traces.

The keyboard 43 may include a “help” key that, when pressed, causes a user interface of an application or web browser executing on the tablet computing device 25 to be presented. The user interface may include tutorials of how to use the keyboard 43 and/or the touchpad 46. In some embodiments, when a particular tutorial is selected, the keys associated with performing an operation described in the tutorial may be illuminated by their respective LEDs. For example, the tablet computing device 25 may transmit an indication that indicates the particular tutorial is selected to the electronic device 21. The processing device of the electronic device 21 may receive the indication and retrieve information pertaining to the particular tutorial. The information may specify (i) which keys are associated with the particular tutorial and a series of key presses that are involved over stages of the tutorial, (ii) a brightness level of the LEDs, and/or (iii) a color of the LEDs. The processing device may send instructions to illuminate accordingly to the appropriate LEDs during the series of key presses involved over the stages of the tutorial. The tablet computing device 25 and the electronic device 21 may transmit messages back and forth during the tutorial to coordinate which screen is presented on the user interface and which keys are illuminated by the LEDs. There are numerous embodiments pertaining to functionality of the processing device of the electronic device 21 controlling the LEDs, as described further herein.

The keyboard 43 may include two shift keys 156 substantially similar or the same in size. The size of the shift keys 156 may be extended horizontally to enable easier access to the shift keys 156.

FIG. 9 is an isometric view of an embodiment of the cable 81 connected to the tablet computing device 25, the electronic device 21, and a cord 202. As depicted, the cord 202 includes a male dual-directional connector 200 (e.g., a Lightning connector by Apple, a USB-C connector, etc.) inserted into the female dual-directional connector 89 of the head 85. Further, the cord 202 may be connected to a power adapter plugged into a power outlet. The male connector 87 of the cable 81 is inserted into a female dual-directional connector of the tablet computing device 25. In some embodiments, the male connector 87 may be unidirectional and the female connector of the table computing device 25 may be unidirectional. Further, the male connector 83 (e.g., unidirectional, such as USB) is inserted into a female connector 206 (e.g., unidirectional, such as USB) of the electronic device 21. The female connector 206 may also be referred to as a first interface 206 herein.

The PCBA 56 may be electrically connected and communicatively coupled to the female connector 206. As such, when the male connector 83 is inserted into female connector 206 and the male connector 87 is inserted into female connector of the tablet computing device 25, the processing device of the PCBA 56 may receive data signals from the female connector 206.

In this configuration, the cable 81 may enable communicating data between the electronic device 21 and the tablet computing device 25. The data may include instructions pertaining to the gestures made on the touchpad 46, information about one or more applications executing on the operating system of the tablet computing device 25, information about settings of the tablet computing device 25, and the like. The cable 81 also provides power to both the tablet computing device 25 and the electronic device 21 via the cord 202 is connected to the cable 81 and the power outlet. Accordingly, cable 81 serves dual functions of providing data between the electronic device 21 and the tablet computing device 25, and providing power to both the electronic device 21 and the tablet computing device 25.

In this configuration, the electronic device 21 and the tablet computing device 25 may communicate with each other via the cable 81 using a communication interface, such as universal serial bus-C (USB-C)/USB-A. In some embodiments, the electronic device 21 and the tablet computing device 25 may not be connected via a network, such as Bluetooth. In some embodiments, the electronic device 21 and the tablet computing device 25 may be connected via a network, such as Bluetooth. In such an embodiment, the wired connection via the cable 81 or the wireless connection via the network may be selected for use based on which connection has the lower bandwidth and/or higher data packet speed.

In some embodiments, the electronic device 21 may also include a TransFlash/secure digital (TF/SD) card interface 208 (also referred to as second interface 208 herein). The TF/SD card interface 208 may be used to expand the memory of the electronic device 21 when a TF/SD card is inserted into the TF/SD card interface 208. Other embodiments may include:
an HDMI or mini-HDMI interface for audio-visual output to an external display;
a DisplayPort or mini-DisplayPort interface for audio-visual output to an external display;
USB-C and/or USB-A interfaces for connecting components such as external hard drives, digital cameras, computer mice, etc.; and/or
a 3.5 mm auxiliary interface for connecting microphones, headphones, external speakers, etc.

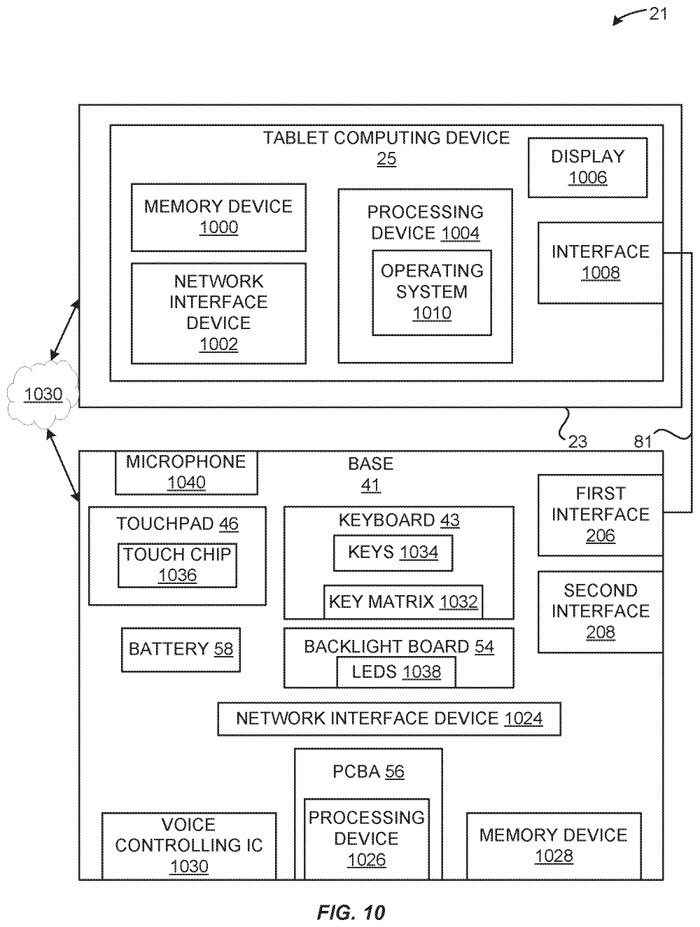

FIG. 10 illustrates a high-level component diagram of an illustrative system architecture of the electronic device 21 configured to releasably mount or removably secure the tablet computing device 25 in the housing 23. The electronic device 21 includes the housing 23 that is rotatably coupled (not shown) to the base 41. The tablet computing device 25 may be a device separate from the electronic device 21. The tablet computing device 25 may be removably secured within the housing 23 and communicatively coupled to the electronic device 21.

In some embodiments, the tablet computing device 25 includes various components, such as a memory device 1000, a network interface device 1002, a processing device 1004, a display 1006, an interface 1008, and so forth. The display 1006 may be any suitable display, such as a liquid crystal display (LCD). The tablet computing device 25 may receive inputs via the display 1006 that includes a touchscreen. The tablet computing device 25 may also receive inputs from the communicatively coupled electronic device 21 based on keyboard 43 keystrokes and touchpad 46 gestures. The memory device 1000 may store computer instructions implementing an operating system 1010 that is executed by the processing device 1004.

The operating system 1010 may be any suitable operating system (e.g., Windows by Microsoft, iOS by Apple, Linux, Android etc.). The operating system 1010 may manage the hardware and software resources of the tablet computing device and provide services for applications executing the processing device 1004. The operating system 1010 may also support a variety of network protocols and/or communication interfaces. For example, the operating system 1010 may support a wireless network connection, such as Bluetooth, to allow the electronic device 21 to access resources, operations, and/or services of the operating system 1010. Also, the operating system 1010 may support a wired connection via the cable 81 and the interface 1008, such as a USB-C/USB-A interface, to allow the electronic device to access resources, operations, and/or services of the operating system. When the cable 81 is inserted into first interface 206 (female connector) and interface 1008 (female connector), the electronic device 21 and the tablet computing device 25 may communicate data to one another. The electronic device 21 may control operation of the tablet computing device 25 via any suitable connection.

The base 41 of the electronic device 21 may include various components, such as the PCBA 56, the touchpad 46, the keyboard 43, the backlight board 54, the battery 58, a first interface 206, a second interface 208, a network interface device 1024, a memory device 1028, and a voice-controlling integrated circuit 1030. The PCBA 56 may include a processing device 1026 and/or various input/output devices. The touchpad 46 may include a touch chip 1036, described further below. The keyboard 43 may include a key matrix 1032, described further below. The backlight board 54 may include a set of LEDs 1038, described further below. In some embodiments, the PCBA 56 and the processing device 1026 may be electrically connected and/or communicatively coupled to the network interface device 1024, the memory device 1028, the voice-controlling integrated circuit 1030, the touch chip 1036, the LEDs 1038, the key matrix 1032, the first interface 206, and/or the second interface 208. For example, the processing device 1026 may be configured to receive instructions from the touch chip 1036, the key matrix 1032, the first interface 206, the second interface 208, the network interface device 1024, the memory device 1028, and/or the voice-controlling integrated circuit 1030. Further, the processing device 1026 may be configured to provide instructions to the network interface device 1024, the first interface 206, the second interface 208, the memory device 1028, and/or the LEDs 1038.

The battery 58 may be electrically connected to the PCBA 56. The battery 58 may be any suitable amount of volts (e.g., 2-10). The battery may be rechargeable. Power may be supplied from the battery 58 to the PCBA 56. Also, power may be supplied from the battery 58 through the PCBA 56 to the other components (e.g., touch chip 1036, key matrix 1032, LEDs 1038, network interface device 1024, memory device 1028, voice-controlling integrated circuit 1030, first interface 206, and second interface 208) of the base 41 via the electrical connections between the PCBA 56 and those other components.

The network interface devices 1024 and 1002 may enable communication via a wireless protocol for transmitting data over short distances, such as Bluetooth, ZigBee, near field communication (NFC), etc. The network interface devices 1024 and 1002 may include a radio frequency (e.g., Bluetooth) integrated circuit for communicating with each other via a network 1030 (e.g., Bluetooth). Additionally, the network interface devices 1024 and 1002 may enable communicating data over long distances. For example, the network 1030 may be a public network (e.g., wireless (WiFi)), a private network (e.g., a local area network (LAN), a wide area network (WAN), a virtual private network (VPN)), or a combination thereof.

In some embodiments, the electronic device 21 and the tablet computing device 25 may communicate with each other via the cable 81 connected to the first interface 206 and the interface 1008. Each of the first interface 206 and the interface 1008 may implement USB-C or USB-A communication interfaces, among any other suitable communication interface.

The processing device 1004 and 1026 may represent one or more general-purpose processing devices such as a microprocessor, central processing unit, or the like. More particularly, the processing device 1004 and 1026 may be a complex instruction set computing (CISC) microprocessor, reduced instruction set computing (RISC) microprocessor (e.g., an advanced RISC machine (ARM)), very long instruction word (VLIW) microprocessor, or processor implementing other instruction sets or processors implementing a combination of instruction sets. The processing devices 1004 and 1026 may also be one or more special-purpose processing devices such as an application specific integrated circuit (ASIC), a field programmable gate array (FPGA), a digital signal processor (DSP), a network processor, or the like. The processing device 1026 may be configured to execute instructions for performing one or more of the operations and steps discussed herein.

The memory devices 1000 and 1028 may include a main memory (e.g., read-only memory (ROM), solid state drive (SSD), flash memory, dynamic random access memory (DRAM) such as synchronous DRAM (SDRAM)), a static memory (e.g., solid state drive (SSD), flash memory, static random access memory (SRAM)), and/or a data storage device. The memory device 1028 may store computer instructions executable by the processing device 1026 to perform the techniques described herein.

The voice-controlling integrated circuit 1030 may be capable of receiving sound signals representing sounds, such as a voice of a user, via an input device (e.g., microphone 1040). In some embodiments, this voice control feature can include compatibility with Amazon Alexa, Google Home, Google Assistant, Bixby, Siri etc. The voice-controlling integrated circuit 1030 may transmit the sound signals to the processing device for processing. In some embodiments, the voice-controlling integrated circuit 1030 may process the received sound signals. For example, the voice-controlling integrated circuit 1030 may use an application (e.g. source code compiled using a software development tool) to convert the sound signal to an analog electrical signal and use an analog-to-digital converter to convert the analog electrical signal to a digital signal which may preferably include binary coded values representing the voice. In some embodiments, the processing device may convert the sound signal into the digital signal.

The keyboard 43 may include a set of keys 1034 each above the key matrix 1032. The key matrix 1032 may refer to a grid of circuits underneath the keys 1034 of the keyboard 43. In some embodiments, each circuit is broken at a point below each key 1034. When a key 1034 is pressed, a switch is pressed, completing the circuit and allowing a current to flow through. When the processing device 1026 detects a circuit that is closed, the processing device 1026 may compare the location of that circuit on the key matrix 1032 to a character map stored in memory. The character map may refer to a lookup table that indicates the position of each key in the key matrix 1032 and what each keystroke or combination of keystrokes represents. The processing device 1026 may provide instructions to the network interface device 1024 for transmission to the tablet computing device 25 via the network 1030 pertaining to the keys 1034 that were pressed. The processing device 1026 may provide instructions to the first interface 206 for transmission to the tablet computing device 25 via the cable 81 pertaining to the keys 1034 that were pressed. The tablet computing device 25 may receive the instructions pertaining to the keys 1034 that were pressed and perform an operation accordingly (e.g., enter text in a document corresponding to the keys pressed, pull up a menu corresponding to the keys pressed, etc.).

The touch chip 1036 may include an integrated circuit configured to receive signals from sensors included in the touchpad 46. For example, the sensors may detect a gesture made on the touchpad 46 by one or more fingers of a user. The touch chip 1036 may transmit instructions pertaining to the gesture to the processing device 1026. The processing device 1026 may translate the received instructions to other instructions based on the operating system 1010 executing on the tablet computing device 25. The processing device 1026 may execute computer instructions implementing a touchpad driver to translate the gestures into instructions specific for the operating system 1010. The processing device may send the generated instructions to the tablet computing device 25 either via the network interface device 1024 using the network 1030, or via the first interface 206 using the cable 81. The other instructions may be received by the tablet computing device 25 and executed by the processing device to cause an operation to be performed.

The second interface 208 may include a TransFlash and/or secure digital card reader. The second interface 208 may include circuitry to read and/or write to the TransFlash and/or secure digital card inserted into the second interface 208. The TransFlash and/or secure digital cards may be used to expand memory of the electronic device 21.

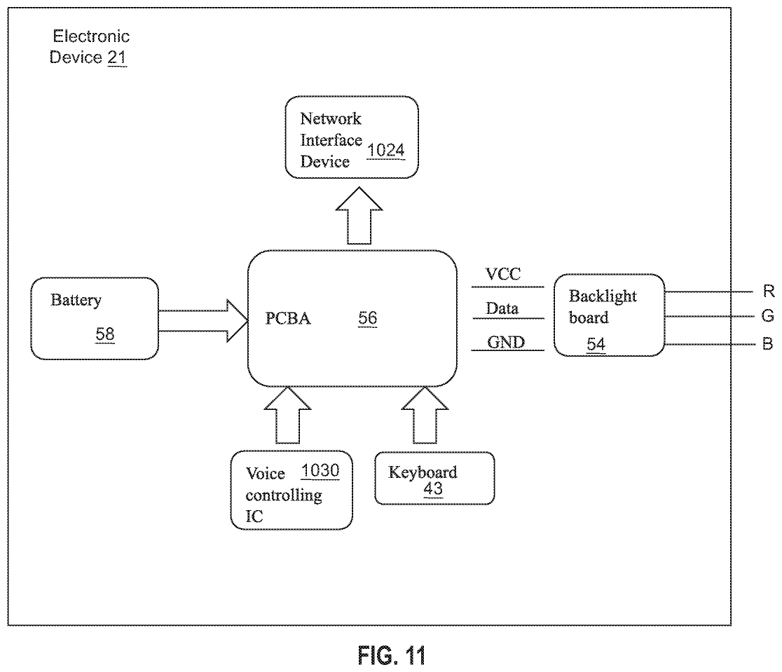

FIG. 11 is a component diagram of an embodiment, including the keyboard 43 and the voice-controlling integrated circuit 1030, of the electronic device 21. In the depicted embodiment, the backlight board 54 may implement a certain number of LEDs (e.g., 60, 70, 80, 90). Each key on the keyboard 43 may be illuminated by a respective LED of the backlight board 54. In this embodiment, the power consumption of turning on the LEDs may be maintained within a specified range, such as 200-300 mA. In one example, the power consumption of operating the LEDs may be approximately 280 mA.

The battery 58 may provide the power to the PCBA 56, which provides power to the connected components as described above. In the depicted embodiment, to enable typing on the tablet computing device 25 using voice control in the electronic device 21, a user may download an application capable of executing instructions to convert analog signals to digital signals. The application may be downloaded from a website and/or an application store installed on the tablet computing device 25. In some embodiments, the user may download the application onto the electronic device 21 using the tablet computing device 25.

As discussed above, the voice-controlling integrated circuit 1030 may receive a sound signal from the microphone 1040. The voice-controlling integrated circuit 1030 may convert the sound signal to an analog signal. The voice-controlling integrated circuit 1030 may convert the analog signal to a digital signal by executing the downloaded application described above to determine which letters or words in a character map correspond to the analog signal. The voice-controlling integrated circuit 1030 may transmit the digital signal to the processing device 1026 of the PCBA 56. The processing device 56 may transmit the digital signal to the network interface device 1024. The network interface device 1024 may transmit the digital signal to the network device 1002 of the tablet computing device 25. The operating system 1010 may perform operations in accordance with the received digital signal (e.g., such as typing the spoken words in a word processing application, or performing a particular operation specified in the spoken words).

In some embodiments, the application may be downloaded and installed on the tablet computing device 25. The voice-controlling integrated circuit 1030 may receive a sound signal from the microphone 1040. The voice-controlling integrated circuit 1030 may convert the sound signal to an analog signal. The voice-controlling integrated circuit 1030 may convert the analog signal to a digital signal using an analog-to-digital converter and transmit the digital signal to the PCBA 56. The PCBA 56 may transmit the digital signal to the tablet computing device 25 via the network interface device 1024. The tablet computing device 25 may process the digital signal using the downloaded application to perform an operation in accordance with the digital signal.

The processing device 1026 of the PCBA 56 may receive information from the keyboard 43 and/or the tablet computing device 25 to change a brightness and/or color of the LEDs disposed on the backlight board 54. Further, the PCBA 56 may receive information from the tablet computing device 25, such as a change in volume of a speaker, or which tutorial is selected to be presented by the tablet computing device 25. Based on the information, the processing device 1026 may provide a corresponding supply voltage (VCC) to the backlight board 54, a data signal including brightness and color of the light, and a ground signal which refers to a reference point for signals or a common path in an electrical circuit from which the voltages can be measured. The LEDs of the backlight board 54 may produce RGB light for some or all of the LEDs based on the received signals from the processing device 1026.

Further, the keyboard 43 may provide information to the PCBA 56 via the electrical connection between the key matrix 1032 and the PCBA 56. For example, when a key is pressed, the signal from a circuit associated with that key may be sent to the PCBA 56. The processor 1026 may determine what key is pressed and transmit that information via the network interface device 1024 to the tablet computing device 25.

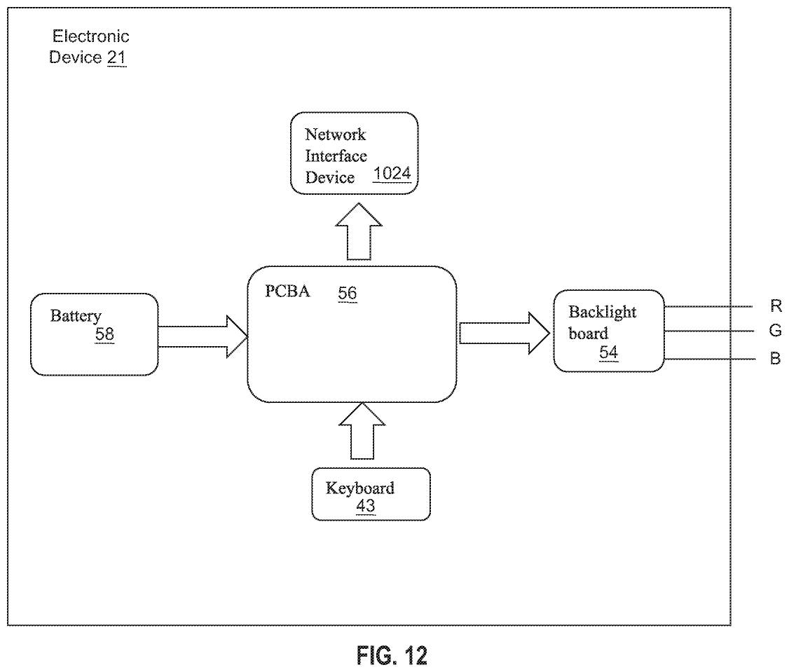

FIG. 12 is a component diagram of an embodiment of an electronic device 21 including a keyboard 43. The keyboard 43 may provide information to the PCBA 56 via the electrical connection between the key matrix 1032 and the PCBA 56. For example, when a key is pressed, the signal from a circuit associated with that key may be sent to the PCBA 56. The processor 1026 may determine what key is pressed and transmit that information via the network interface device 1024 to the tablet computing device 25.

The backlight board 54 may function similarly as described with reference to FIG. 11.

In one implementation of the embodiment depicted in FIG. 12, a small number of LEDs may be used, such as 2-10. In one example, 7 LEDs may be disposed on the backlight board 54. If each of the 7 LEDs consumes 30 mA and the battery is 4 volts, the power consumption may be 210 mA if the 7 LEDs are turned on at the same time.

In another implementation of the embodiment depicted in FIG. 12, a larger number of LEDs may be used, such as 60-100. In one example, 80 LEDs may be disposed on the backlight board 54. If each of the 7 LEDs consumes 5 mA and the battery is 4 volts, the power consumption may be around 400 mA. In some embodiments, the power consumption may be maintained within a certain threshold (e.g., 200-300) using pulse width modulation and setting the LEDs to be a percentage (e.g., 50-80 percent) of their maximum brightness.

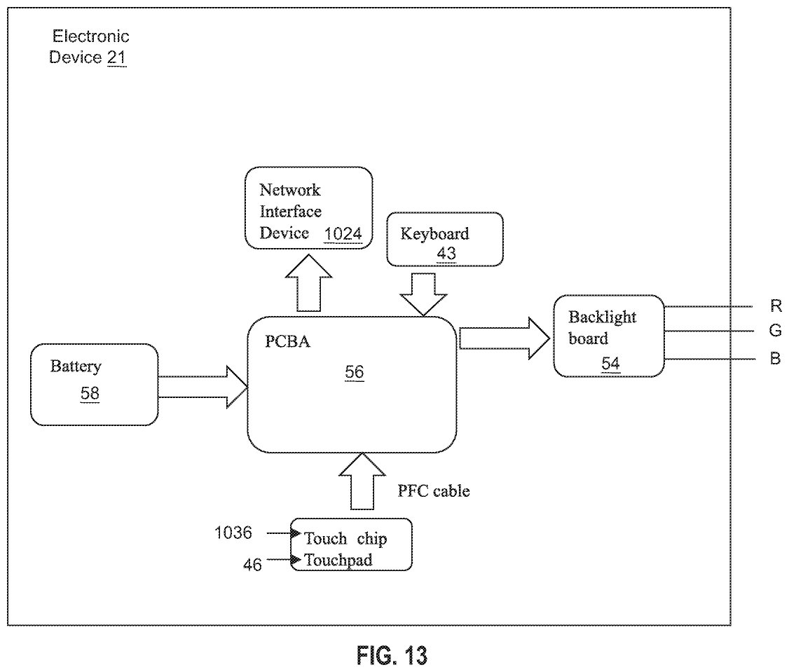

FIG. 13 is a component diagram of an embodiment of an electronic device 21 including a keyboard 43 and a touchpad 46. The battery 58, the keyboard 43, the backlight board 54, the PCBA 56, and the network interface device 1024 may perform similarly as described with reference to FIGS. 11 and 12. The touch chip 1036 may be connected to the PCBA 56 via a power factor correction (PFC) cable. The PFC cable may reduce the amount of reactive power generated by the touchpad 46 to improve the signal quality carrying the instruction representing the gesture.

The depicted embodiment in FIG. 13 includes the touchpad 46 with the touch chip 1036. The user may perform a gesture on the touchpad 46 such as a single-touch motion or multi-touch motion. The touch chip 1036 may detect the gesture via one or more sensors and transmit an instruction corresponding to the gesture to the PCBA 56. The PCBA 56 may generate a second instruction based on the first instruction. The PCBA 56 may transmit the second instruction to the tablet computing device 25 via the network interface device 1024.

In some embodiments, the touch chip 1036 may use two cables to transmit data. One cable may be for serial data (SDA) that refers to the line for a master and slave to send and receive data, and the other cable may be for a serial clock (SCL) that refers to the line that carries the clock signal. The disclosed embodiments may prevent loss of data and may achieve better resolution when collecting data from the touch chip 1036. If the tablet computing device 25 enters sleep mode, the disclosed techniques enable awakening the tablet computing device 25 within 400-600 milliseconds (ms) of entering that mode. In one embodiment, the awakening may be within 500 ms.

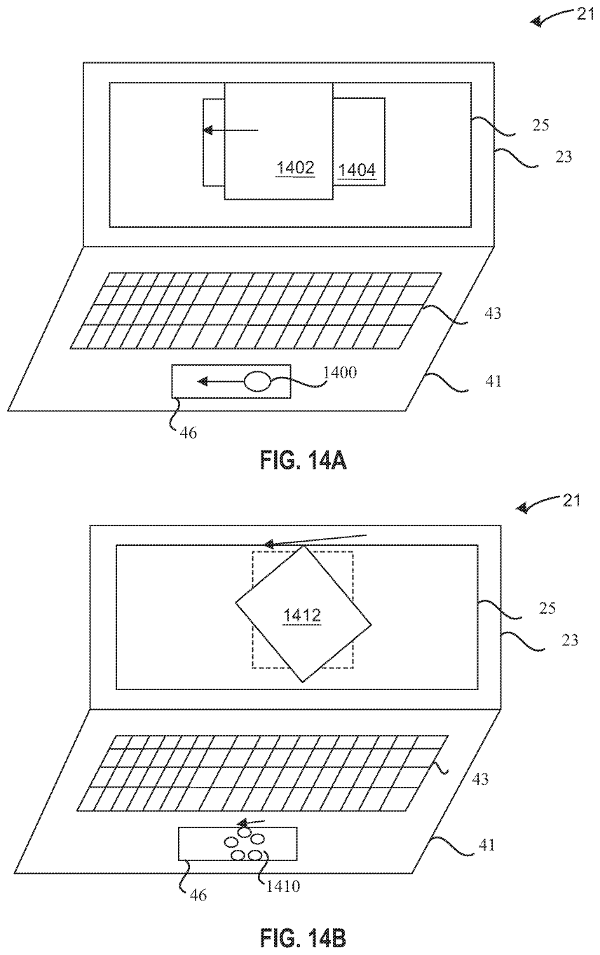

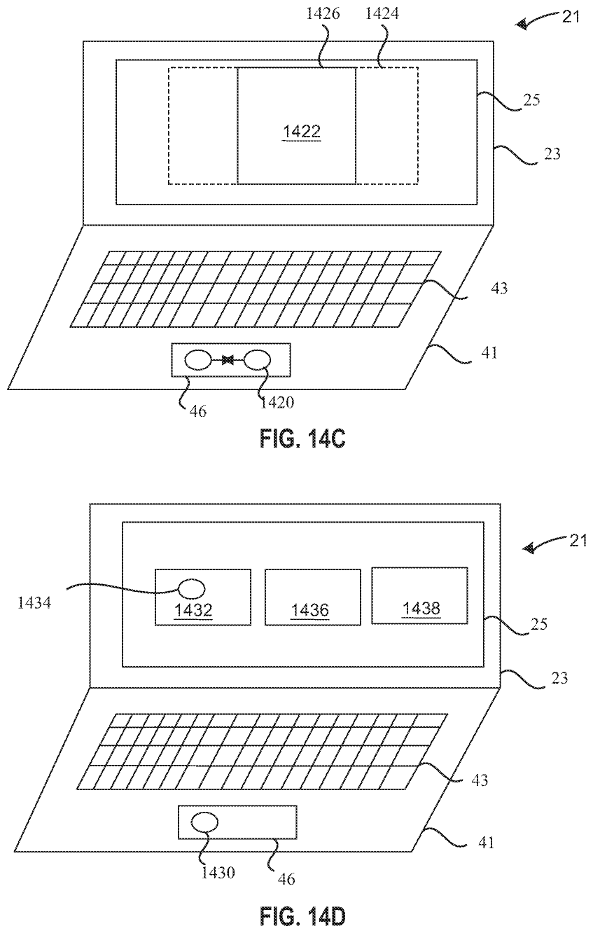

FIGS. 14A-14D are isometric views of embodiments of using touch motions on a touchpad 46 to cause an operation to be performed on a tablet computer 25. The electronic device 21 may be communicatively coupled to the tablet computing device 25 removably secured in the housing 23 of the electronic device 21. As depicted in FIG. 14A, the user has made a gesture by performing a single-touch motion (represented by circle 1400) with a finger and dragging their finger across the touchpad 46 (represented by left arrow). The gesture may represent a swipe motion.

The processing device 1026 may receive an instruction from the touchpad 46. The instruction may pertain to the gesture. The processing device 1026 may generate a second instruction and transmit the second instruction to the tablet computing device 25. The second instruction may cause the tablet computing device 25 to perform an operation.

For example, as depicted, a current application 1402 is being presented on the tablet computing device 25 as a selected application. The operation performed based on the second instruction includes shifting the currently selected application 1402 to the left (represented by the left arrow) and selecting a new application 1404.

Another example of a user using the touchpad 46 to control operation of the tablet computing device 25 is depicted in FIG. 14B. As depicted, the user made a gesture 1410 including a multi-touch motion using 5 fingers on the touchpad 46. The gesture 1410 included touching the touchpad 46 with the 5 fingers in a circle and rotating the circle counter-clockwise with their fingers (as depicted with the arrow).
The processing device 1026 may receive an instruction from the touchpad 46. The instruction may pertain to the gesture. The processing device 1026 may generate a second instruction and transmit the second instruction to the tablet computing device 25. The second instruction may cause the tablet computing device 25 to perform an operation.

For example, as depicted, object 1412 is being presented on the tablet computing device 25. The operation performed based on the second instruction includes rotating the object 1412 counter-clockwise (represented by the arrow).

Another example of a user using the touchpad 46 to control operation of the tablet computing device 25 is depicted in FIG. 14C. As depicted, the user made a gesture 1420 including a multi-touch motion using 2 fingers on the touchpad 46. The gesture 1420 included touching the touchpad 46 with the 2 fingers spaced apart a first distance and moving the 2 fingers closer together to a second distance shorter than the first distance (as depicted with the left and right arrows).

The processing device 1026 may receive an instruction from the touch pad 46. The instruction may pertain to the gesture. The processing device 1026 may generate a second instruction and transmit the second instruction to the tablet computing device 25. The second instruction may cause the tablet computing device 25 to perform an operation.

For example, as depicted, application 1422 was presented on the tablet computing device 25 at a first time having a first width 1424. The operation performed based on the second instruction includes shrinking the width of the application 1422 at a second time to a second width 1426 smaller than the first width.

Another example of a user using the touchpad 46 to control operation of the tablet computing device 25 is depicted in FIG. 14D. As depicted, the user made a gesture 1430 including a single-touch motion using 1 finger on the touchpad 46. The gesture 1430 included touching the touchpad 46 at a location on the touchpad 1430 that corresponds to a location on the user interface of the tablet computing device 25 where an icon of an application resides.

The processing device 1026 may receive an instruction from the touchpad 46. The instruction may pertain to the gesture 1430. The processing device 1026 may generate a second instruction and transmit the second instruction to the tablet computing device 25. The second instruction may cause the tablet computing device 25 to perform an operation.

For example, as depicted, applications 1432, 1436, and 1438 are presented on the tablet computing device 25. The operation performed based on the second instruction includes selecting (circle 1434) the application 1432 that corresponds to the location of the gesture 1430. The selection may cause the application 1432 to be opened on the tablet computing device 25.

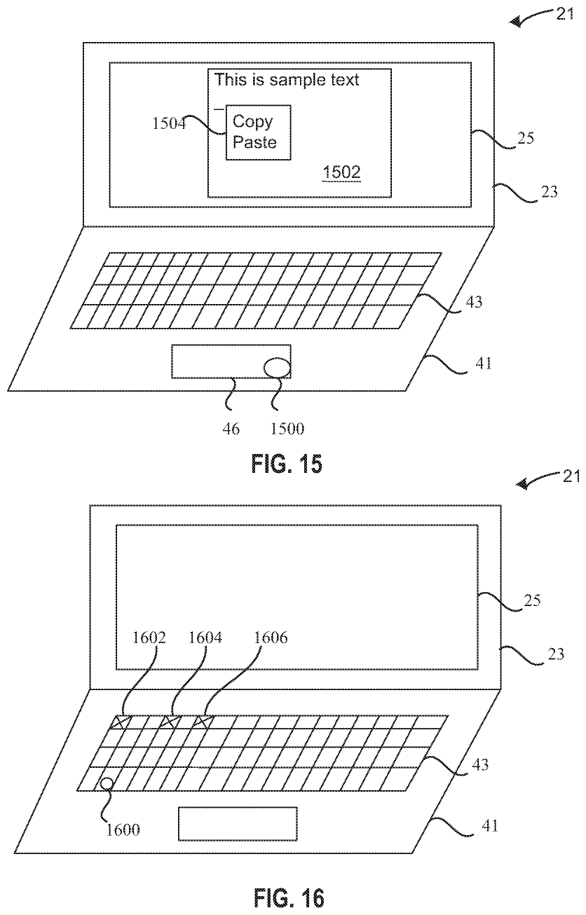

FIG. 15 is an isometric view of an embodiment of touching a portion of the touchpad 46 to cause a contextual menu 1504 to be presented on the tablet computing device 25. As depicted, the user made a gesture 1500 including a single-touch motion using one finger on the touchpad 46 by touching a portion of the touchpad 46. Touching the portion at the portion may simulate a “right-click” of a mouse.

The processing device 1026 may receive an instruction from the touchpad 46. The instruction may pertain to the gesture 1500. The processing device 1026 may generate a second instruction and transmit the second instruction to the tablet computing device 25. The second instruction may cause the tablet computing device 25 to perform an operation.

For example, as depicted, application 1502 is presented on the tablet computing device 25. The application 1502 may be a word processing application and a document may be drafted within the application 1502. The operation performed based on the second instruction includes opening the contextual menu 1504 at the location of the cursor in the document of the application 1502. The contextual menu 1504 may include various options such as “copy”, “paste”, etc.

FIG. 16 is an isometric view of an embodiment of pressing a function key 1600 to cause certain LEDs to illuminate (represented by the X's) certain keys 1602, 1604, and 1606. The keys 1602, 1604, and 1606 illuminated by their respective LEDs may correspond to keys that each perform a different function when pressed in combination with the function key 1600.

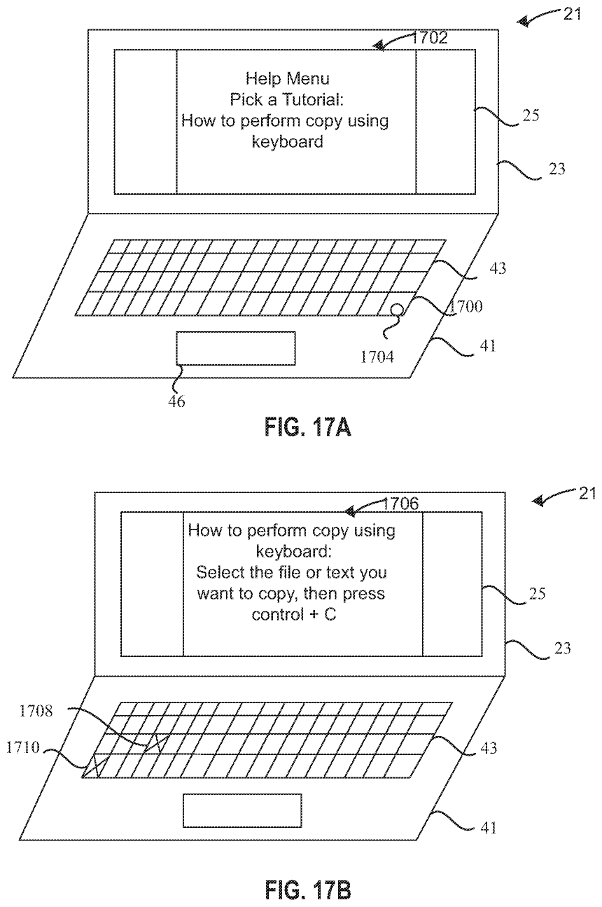

FIG. 17A-17B are isometric views of embodiments of pressing (circle 1704) a help key 1700 to cause tutorials 1702 pertaining to how to use the electronic device 21 to be presented on the tablet computing device 25. The tutorials 1702 may be presented in a website or an application on the tablet computing device 25. In the depicted example, the tutorials 1702 include the text “Help Menu Pick a Tutorial: How to make a copy using the keyboard”. In this example, the user may select the “How to make a copy using the keyboard” tutorial 1702 by using the touch pad 46.

As depicted in FIG. 17B, the selection of the tutorial may cause the LEDs associated with the keys 1708 and 1710 to illuminate (represented by the X's). The user interface of the website or application presenting the tutorials may change to a screen 1706 that includes text “How to make a copy using the keyboard: Select the file or text you want to copy, then press control +C”. Thus, key 1710 may correspond to the “control” key, and key 1708 may correspond to the “C” key. As the tutorial 1702 progresses, if there are any more steps involving different keys at different stages, those keys may be illuminated via their respective LEDs.

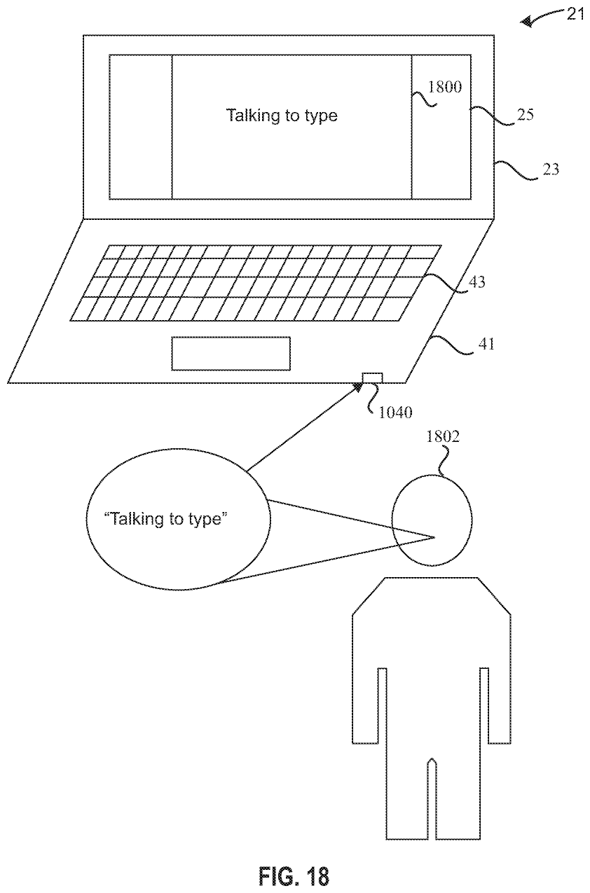

FIG. 18 is an isometric view of an embodiment of a user 1802 causing text to be presented on the tablet computing device 25 by talking into the electronic device 21. As depicted, the microphone 1040 may be included in the base 41 of the electronic device 21. The user says “Talking to type”. The microphone 1040 may receive the sound signal and transmit it to the voice-controlling IC 1030. The voice-controlling IC 1030 may convert the sound signal to an analog signal, then convert the analog signal to a digital signal. The digital signal may be output to the tablet computing device 25 and the digital signal may cause application 1800 to perform an operation. The application 1800 may be a word processing application and the operation may include typing text based on the digital signal. As depicted, the application 1800 types the text “Talking to type”.

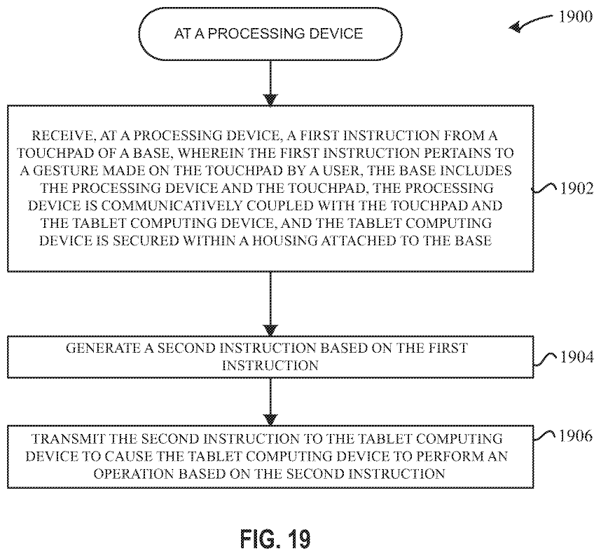

FIG. 19 is an example flow diagram of a method 1900 for using a touch pad 46 of an electronic device 21 to cause an operation to be performed on a tablet computing device 25. The method 1900 may be performed by processing logic that may include hardware (circuitry, dedicated logic, etc.), software, or a combination of both. The method 1900 and/or each of their individual functions, subroutines, or operations may be performed by one or more processors of a computing device (e.g., electronic device 21) implementing the method 1900. The method 1900 may be implemented as computer instructions stored on a memory device and executable by the one or more processors. In certain implementations, the method 1900 may be performed by a single processing thread. Alternatively, the method 1900 may be performed by two or more processing threads, each thread implementing one or more individual functions, routines, subroutines, or operations of the methods.

Prior to describing the method 1900, it should be understood that the base 41 may include the touchpad 46, the keyboard 43, the processing device 1026, the memory device 1028, the network interface device 1024, the LEDs 1038, the first interface 206 and the second interface 208, and the touchpad 46, among other components. The processing device 1026 may be communicatively coupled with the network interface device 1024 and the touchpad 1036. The network interface device 1024 may be communicatively coupled with the network interface device 1002 of the tablet computing device 25 via the network 1030 (e.g., Bluetooth). Additionally or alternatively, the first interface 206 may be communicatively coupled with the interface 10008 of the tablet computing device 25 via the cable 81.

At block 1902, the processing device 1026 may receive a first instruction from a touchpad 46. In some embodiments, a touch chip 1036 included in the touchpad 46 may transmit the first instruction to the processing device 1026. The first instruction may pertain to a gesture made on a surface of the touchpad 46.

The gesture may include a single-touch or multi-touch motion on the touchpad 46. For example, regarding single-touch motion, the user may use one finger to tap or touch the touchpad 46, to touch the touchpad 46 and drag their finger across the touchpad 46, to perform a series of taps (e.g., double tap), or the like.

Regarding multi-touch motion, the user may use more than one finger (e.g., 2, 3, 4, 5, 6, 7, 8, 9, 10) to touch the touchpad 46 and perform a motion. The motion may include placing fingers close to each other at a location on the touchpad 46 and expanding a distance between the fingers, placing the fingers apart from each other at a location on the touchpad 46 and closing a distance between the fingers, tapping the touchpad 46 with fingers, tapping the touchpad 46 with fingers and dragging the fingers in a direction across the touchpad 46, placing multiple fingers on the touchpad 46 and rotating them counter-clockwise or clockwise in a circle, and the like.

The touchpad 46 may capture the gesture using sensors and the touch chip 1036 may transmit one or more first instructions pertaining to the gesture to the processing device 1026 of the electronic device 21. At block 1904, the processing device 1026 may receive the first instruction and generate a second instruction based on the first instruction. In some embodiments, the processing device 1026 may generate the second instruction based on a type of operating system 1010 executing on the tablet computing device 25. For example, the second instruction may be generated to comply with an interface or specification defined by the operating system to properly perform function calls and/or access software/hardware resources of the tablet computing device 25.

At block 1904, the processing device may transmit the second instruction to the table computing device 25 to cause the tablet computing device 25 to perform an operation based on the second instruction. More specifically, the processing device 1026 may transmit the second instruction to tablet computing device 25 using the network interface device 1024 via the network 1030, or may transmit the second instruction to the tablet computing device 25 using the first interface 206 via the cable 81.

In some embodiments, when the gesture is a multi-finger motion on the touchpad 46, the operation may include performing at least one of zooming, switching which application of a set of applications is currently being selected by the operating system 1010, closing an application currently executing via the operating system 1010, opening an application via the operating system 1010, opening a menu via the operating system 1010, or selecting an option included in an application currently executing via the operating system 1010.

In some embodiments, the processing device 1026 may cause, in response to a portion of the touchpad 46 being pressed, a contextual menu to be presented on the tablet computing device 25. The contextual menu may include options pertaining to settings, operations allowed by an application running on the tablet computing device.

In some embodiments, the processing device may change, in response to the function key being pressed, a brightness of an LED disposed beneath another key of the keyboard. The brightness indicating that the another key performs a function when pressed in conjunction with the function key.

In some embodiments, the processing device 1026 may control the set of LEDs to consume power within a specified range. For example, the range may be 200-300 mA.

In some embodiments, the processing device 1026 may pair the electronic device 21 and the tablet computing device 25 via a wireless connection (e.g., Bluetooth) when the one-touch pair key is pressed.

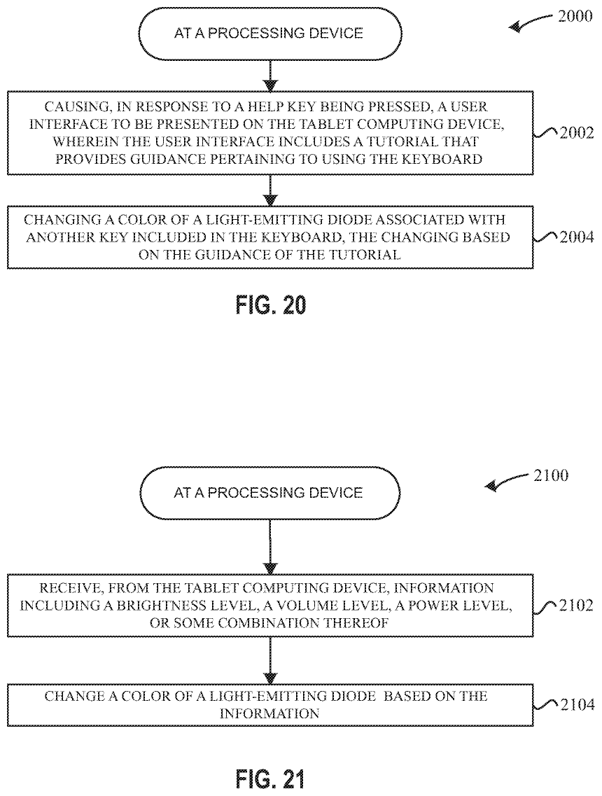

FIG. 20 is an example flow diagram of a method 2000 based on guidance of a tutorial presented on the tablet computing device 25 for changing a color of a light-emitting diode associated with a key of an electronic device 21. Method 2000 includes operations performed by processors of a computing device (e.g., electronic device 21) implementing the method 2000. In some embodiments, one or more operations of the method 2000 are implemented in computer instructions stored on a memory device and executed by a processing device. The method 700 may be performed in the same or a similar manner as described above in regards to method 1900.

At block 2002, the processing device 1026 may cause, in response to a help key being pressed, a user interface to be presented on the table computing device 25. The user interface may include a tutorial that provides guidance pertaining to using the keyboard and/or the touchpad 46.

At block 2004, the processing device 1026 may change a color of an LED associated with the another key included in the keyboard 46. The change of color may be based on the guidance of the tutorial.

FIG. 21 is an example flow diagram of a method 2100 based on information received from the tablet computing device 25 for changing a color of a light-emitting diode included in the base. Method 2100 includes operations performed by processors of a computing device (e.g., electronic device 21) implementing the method 2100. In some embodiments, one or more operations of the method 2100 are implemented in computer instructions stored on a memory device and executed by a processing device. The method 2100 may be performed in the same or a similar manner as described above in regards to method 1900.

At block 2102, the processing device may receive, from the tablet computing device 25, information pertaining to the table computing device 25. The information may include a brightness level, a volume level, a power level, or some combination thereof.

At block 2104, the processing device may change a color of an LED disposed beneath certain keys of the keyboard based on the information. For example, when the volume level of the tablet computing device 25 is at a maximum level, a top row of keys on the keyboard may be illuminated in a certain color (e.g., green). When the volume level is at a medium level, half of the keys of the top row of keys may be illuminated in a certain color (e.g., yellow). When the volume is muted, a first key of the top row of keys may be illuminated a certain color (e.g., red).

Still other versions can include one or more of the following embodiments.

According to an embodiment of this disclosure, an electronic device, comprises:

a housing for releasably mounting a tablet computing device; and

a base rotatably coupled to the housing, the base comprising:

a processing device capable of executing instructions and communicatively coupled to the tablet computing device;

a touchpad communicatively coupled to the processing device, the touchpad capable of receiving a gesture and transmitting a first instruction pertaining to the gesture to the processing device, wherein the processing device generates a second instruction based on the first instruction and transmits the second instruction to the tablet computing device to cause an operation to be performed by an operating system executing on the tablet computing device.

According to an embodiment of this disclosure, the gesture includes a multi-finger motion on the touchpad and the operation includes performing at least one of:

zooming,

switching which application of a plurality of applications is currently being selected by the operating system,

closing an application currently executing via the operating system,

opening an application via the operating system,

opening a menu via the operating system, or

selecting an option included in an application currently executing via the operating system.

According to an embodiment of this disclosure, the base further comprises a keyboard including a plurality of keys, each of the plurality of keys disposed above a light-emitting diode.

According to an embodiment of this disclosure, the base further comprises a keyboard including a help key that, when pressed, causes a user interface to be presented on the tablet computing device, the user interface including a tutorial that provides guidance pertaining to using the keyboard.

According to an embodiment of this disclosure, the base further comprises a keyboard including another key and a light-emitting diode disposed beneath the another key, and a color of the light-emitting diode is changed according to the guidance of the tutorial.

According to an embodiment of this disclosure, the touchpad comprises a first pressable portion that causes a selection operation to be performed by the tablet computing device, and a second pressable portion that causes a contextual menu to be presented on the tablet computing device.

According to an embodiment of this disclosure, the contextual menu includes options pertaining to settings of the tablet computing device, settings of a first application installed on the device, settings of a second application executing on the device, operations allowed by an application executing on the tablet computing device, or some combination thereof.

According to an embodiment of this disclosure, the base further comprises a keyboard including a function key that, when pressed, causes one or more light-emitting diodes disposed beneath one or more keys of the keyboard to illuminate to indicate that the one or more keys perform a function when pressed in conjunction with the function key.

According to an embodiment of this disclosure, the base further comprises a keyboard including light-emitting diodes that change colors based upon a brightness level of a display of the tablet computing device, change colors based upon a volume level of a speaker of the tablet computing device, or both.

According to an embodiment of this disclosure, the base further comprises a keyboard including a plurality of light-emitting diodes arranged to consume power within a specified range.

According to an embodiment of this disclosure, the base further comprises a keyboard including a one-touch pair key capable of pairing the electronic device and the tablet computing device via a wireless connection with a single push of the one-touch pair key.

According to an embodiment of this disclosure, a method comprises:

receiving, at a processing device, a first instruction from a touchpad of a base, wherein:

the first instruction pertains to a gesture made on the touchpad by a user,

the base comprises the processing device and the touch pad,

the processing device is communicatively coupled with the touchpad and a tablet computing device, and

the tablet computing device is releasably mounted within a housing attached to the base;

generating a second instruction based on the first instruction; and

transmitting the second instruction to the tablet computing device to cause the tablet computing device to perform an operation based on the second instruction.

According to an embodiment of this disclosure, the gesture includes a multi-finger motion on the touchpad and the operation includes performing at least one of:

zooming,

switching which application of a plurality of applications is currently selected by the operating system,

closing an application currently executing via the operating system,

opening an application via the operating system,

opening a menu via the operating system, or

selecting an option included in an application currently executing via the operating system.

According to an embodiment of this disclosure, the base further comprises a keyboard including a help key; and
the method further comprises causing, in response to a help key being pressed, a user interface to be presented on the tablet computing device, wherein the user interface includes a tutorial that provides guidance pertaining to using the keyboard.

According to an embodiment of this disclosure, the keyboard includes another key; and
the method further comprises changing a color of a light-emitting diode associated with the another key included in the keyboard, the changing based on the guidance of the tutorial.

According to an embodiment of this disclosure, further comprising causing, in response to a portion of the touchpad being pressed, a contextual menu to be presented on the tablet computing device, wherein the menu includes options pertaining to settings, operations allowed by an application running on the tablet computing device, or some combination thereof.

According to an embodiment of this disclosure, wherein the base further comprises a keyboard including a function key and another key; and
the method further comprises changing, in response to the function key being pressed, a brightness of a light-emitting diode disposed beneath the another key of the keyboard, the brightness indicating that the another key performs a function when pressed in conjunction with the function key.

According to an embodiment of this disclosure, the base further comprises a keyboard and a light-emitting diode; and
the method further comprises:

receiving, from the tablet computing device, information comprising a brightness level, a volume level, a power level, or some combination thereof; and

changing a color of the light-emitting diode based on the information.

According to an embodiment of this disclosure, the base comprises a keyboard including a plurality of light-emitting diodes; and
the method further comprises controlling the plurality of light-emitting diodes to consume power within a specified range.

According to an embodiment of this disclosure, the base further comprises keyboard including a one-touch pair key; and
the method further comprises:

when the one-touch pair key is pressed, pairing the electronic device and the tablet computing device via a wireless connection.

According to an embodiment of this disclosure, a tangible, computer-readable medium stores instructions that, when executed, cause a processing device included in a base to:

receive a first instruction from a touchpad included in the base of an electronic device, wherein:

the first instruction pertains to a gesture made on the touchpad by a user, and

the processing device is communicatively coupled with the touchpad and a tablet computing device that is releasably mounted within a housing attached to the base;

generate a second instruction based on the first instruction; and
transmit the second instruction to the tablet computing device to cause the tablet computing device to perform an operation based on the second instruction.

According to an embodiment of this disclosure, an electronic device, comprising:

a housing configured to releasably mount a tablet computing device thereto; and

a base hingedly coupled to the housing, the base comprises a keyboard configured to interface with the tablet computing device, the base also comprises a top on which the keyboard is located, a bottom opposite the top, the bottom having a bottom surface that is flat and a curved surface adjacent a perimeter of the base, the curved surface extends between the flat bottom surface and the top; and the base further comprises:
footpads on the curved surface.

According to an embodiment of this disclosure, the footpads are entirely located on the curved surface and not on the flat bottom surface.

According to an embodiment of this disclosure, the footpads are located within 8 mm of the perimeter.

According to an embodiment of this disclosure, the footpads are sloped.

According to an embodiment of this disclosure, a hinge is mounted to the housing and the base, and the hinge has a first degree of freedom configured to swivel the housing relative to the base, and a second degree of freedom configured to fold the housing relative to the base.

According to an embodiment of this disclosure, the hinge comprises a housing mount having a housing mount width, the housing has a housing width, and the housing mount width is in a range of about 42% to about 60% of the housing width, or about 43% to about 50% of the housing width.

According to an embodiment of this disclosure, the hinge comprises a base mount having a base mount width, the base has a base width, and the base mount width is in a range of about 20% to about 35% of the base width, or about 28% to about 33% of the base width.

According to an embodiment of this disclosure, the housing and the base are injected molded, each of the housing and the base comprises copper nuts to which the hinge is mounted, and the copper nuts are mounted in the housing and the base during the injected molding process.

According to an embodiment of this disclosure, further comprising a power cable comprising a male unidirectional connector on a first end, and a second end comprising a head having a male dual-directional connector and a female dual-directional connector.

According to an embodiment of this disclosure, the base comprises keyholes through which respective keys on the keyboard protrude, the base comprises an interior surface that is visible to a user through the keyholes, the keys have a key color, and the interior surface has an interior surface color with a light reflectance value (LRV) in a range of about 50% to about 80%.

According to an embodiment of this disclosure, the key color comprises an LRV that is less than about 40%.

According to an embodiment of this disclosure, the base further comprises a touchpad configured to interface with the tablet computing device.

According to an embodiment of this disclosure, an electronic device comprises:

a housing configured to releasably mount a tablet computing device thereto;

a base movably coupled to the housing, the base comprising a keyboard configured to interface with the tablet computing device, and a touchpad configured to interface with the tablet computing device; and

a hinge mounted to the housing and the base, the hinge has a first degree of freedom configured to swivel the housing relative to the base, and a second degree of freedom configured to fold the housing relative to the base.

According to an embodiment of this disclosure, the base comprises a top on which the keyboard is located, a bottom opposite the top, the bottom having a bottom surface that is flat and a curved surface adjacent a perimeter of the base, the curved surface extends between the flat bottom surface and the top; and the base further comprises:
footpads on the curved surface.

According to an embodiment of this disclosure, the footpads are entirely located on the curved surface and not on the flat bottom surface.

According to an embodiment of this disclosure, the footpads are located within 8 mm of the perimeter, and the footpads are sloped.

According to an embodiment of this disclosure, the hinge comprises a housing mount having a housing mount width, the housing has a housing width, and the housing mount width is in a range of about 43% to about 50% of the housing width.

According to an embodiment of this disclosure, the hinge comprises a base mount having a base mount width, the base has a base width, and the base mount width is in a range of about 20% to about 35% of the base width.

According to an embodiment of this disclosure, further comprising a power cable comprising a male unidirectional connector on a first end, and a second end comprising a head having a male dual-directional connector and a female dual-directional connector.

According to an embodiment of this disclosure, he base comprises key holes through which respective keys on the keyboard protrude, the base comprises an interior surface that is visible to a user through the key holes, the keys have a key color, the interior surface has an interior surface color with a light reflectance value (LRV) in a range of about 50% to about 80%, and the key color comprises an LRV is less than about 40%.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” mean, when comparing various parts to one another, that the parts being compared are equal to or are so close enough in dimension that one of skill in the art would consider them the same. Substantial and substantially, as used herein, are not limited to a single dimension and specifically include a range of values for those parts being compared. The range of values, both above and below (e.g., “+/−” or greater/lesser or larger/smaller), includes a variance that one of skill in the art would know to be a reasonable tolerance for the parts mentioned.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or essential feature of any or all the claims.

After reading the specification, skilled artisans will appreciate that certain features which, for clarity, are described herein in the context of separate embodiments, can also be provided in combination in a single embodiment. Conversely, various features that are, for brevity, described in the context of a single embodiment, can also be provided separately or in any subcombination. Further, references to values stated in ranges include each and every possible value within that range.

What is claimed is:

1. An electronic device, comprising:
a housing configured to releasably mount a tablet computing device thereto; and
a base hingedly coupled to the housing, the base comprises a keyboard configured to interface with the tablet computing device, the base also comprises a top on which the keyboard is located, a bottom opposite the top, the bottom having a bottom surface that is flat and a curved surface adjacent a perimeter of the base, the curved surface extends between the flat bottom surface and the top; and the base further comprises:
footpads on the curved surface.

2. The electronic device of claim 1, wherein the footpads are entirely located on the curved surface and not on the flat bottom surface.

3. The electronic device of claim 1, wherein the footpads are located within 8 mm of the perimeter.

4. The electronic device of claim 1, wherein the footpads are sloped.

5. The electronic device of claim 1, wherein a hinge is mounted to the housing and the base, and the hinge has a first degree of freedom configured to swivel the housing relative to the base, and a second degree of freedom configured to fold the housing relative to the base.

6. The electronic device of claim 5, wherein the hinge comprises a housing mount having a housing mount width, the housing has a housing width, and the housing mount width is in a range of about 42% to about 60% of the housing width, or about 43% to about 50% of the housing width.

7. The electronic device of claim 5, wherein the hinge comprises a base mount having a base mount width, the base has a base width, and the base mount width is in a range of about 20% to about 35% of the base width, or about 28% to about 33% of the base width.

8. The electronic device of claim 5, wherein the housing and the base are injected molded, each of the housing and the base comprises copper nuts to which the hinge is mounted, and the copper nuts are mounted in the housing and the base during the injected molding process.

9. The electronic device of claim 1, further comprising a power cable comprising a male unidirectional connector on a first end, and a second end comprising a head having a male dual-directional connector and a female dual-directional connector.

10. The electronic device of claim 1, wherein the base comprises keyholes through which respective keys on the keyboard protrude, the base comprises an interior surface that is visible to a user through the keyholes, the keys have a key color, and the interior surface has an interior surface color with a light reflectance value (LRV) in a range of about 50% to about 80%.

11. The electronic device of claim 10, wherein the key color comprises an LRV that is less than about 40%.

12. The electronic device of claim 1, wherein the base further comprises a touchpad configured to interface with the tablet computing device.

13. An electronic device, comprising:
a housing configured to releasably mount a tablet computing device thereto;
a base movably coupled to the housing, the base comprising a keyboard configured to interface with the tablet computing device, and a touchpad configured to interface with the tablet computing device; and
a hinge mounted to the housing and the base, the hinge has a first degree of freedom configured to swivel the housing relative to the base, and a second degree of freedom configured to fold the housing relative to the base.

14. The electronic device of claim 13, wherein the base comprises a top on which the keyboard is located, a bottom opposite the top, the bottom having a bottom surface that is flat and a curved surface adjacent a perimeter of the base, the curved surface extends between the flat bottom surface and the top; and the base further comprises:
footpads on the curved surface.

15. The electronic device of claim 14, wherein the footpads are entirely located on the curved surface and not on the flat bottom surface.

16. The electronic device of claim 14, wherein the footpads are located within 8 mm of the perimeter, and the footpads are sloped.

17. The electronic device of claim 13, wherein the hinge comprises a housing mount having a housing mount width, the housing has a housing width, and the housing mount width is in a range of about 43% to about 50% of the housing width.

18. The electronic device of claim 13, wherein the hinge comprises a base mount having a base mount width, the base has a base width, and the base mount width is in a range of about 20% to about 35% of the base width.

19. The electronic device of claim 13, further comprising a power cable comprising a male unidirectional connector on a first end, and a second end comprising a head having a male dual-directional connector and a female dual-directional connector.

20. The electronic device of claim 13, wherein the base comprises key holes through which respective keys on the keyboard protrude, the base comprises an interior surface that is visible to a user through the key holes, the keys have a key color, the interior surface has an interior surface color with a light reflectance value (LRV) in a range of about 50% to about 80%, and the key color comprises an LRV is less than about 40%.
